(19) United States
(12) Patent Application Publication
(10) Pub. No.: US 2016/0245245 A1
(43) Pub. Date: Aug. 25, 2016

(54) Pump

(71) Applicant: CONTINENTAL AUTOMOTIVE GMBH, Hannover (DE)

(72) Inventor: Marc VÖLKER, Magdeburg (DE)

(21) Appl. No.: 15/027,628

(22) PCT Filed: Oct. 9, 2014
(86) PCT No.: PCT/EP2014/071603

§ 371 Date: Apr. 6, 2016

(30) Foreign Application Priority Data
Oct. 10, 2013 (DE) 10 2013 220 451.5

(51) Int. Cl. F02M 37/08

(52) U.S. Cl. CPC F02M 37/08; F02M 2037/082

(57) ABSTRACT

A pump has a housing, in which an electric motor and at least one pump stage that can be driven by a shaft of the electric motor are arranged. An inlet and an outlet are located on opposite sides of the pump housing. Connection lines for contacting the electric motor 3 are led through the inlet side of the pump housing to the electric motor.

### CROSS REFERENCE TO RELATED APPLICATIONS

This is a U.S. national stage of application No. PCT/EP2014/071603 filed on Oct. 9, 2014. Priority is claimed on German Application No. DE10 2013 220 451.5 filed Oct. 10, 2013, the content of which is incorporated here by reference.

### BACKGROUND OF THE INVENTION

1. Field of the Invention

The subject matter of the invention is a pump having a housing, in which an electric motor and at least one pumping stage driven by a shaft of the electric motor are arranged, an inlet and an outlet which are arranged on opposite sides of the pump, and connector lines for contacting the electric motor.

2. Description of the Prior Art

Pumps of this type are known and are used to deliver liquids and gases, in particular fuel in a motor vehicle. The pumps can be arranged both inside and outside the fuel container. Regardless of the arrangement, the fuel is drawn in via an inlet, brought to the desired pressure level in the pumping stage, and delivered by the electric motor to the outlet and via a forward feed line connected thereto to the internal combustion engine of the motor vehicle. The electric motor is contacted by two connector lines routed into the electric motor on the outlet side of the fuel pump. It is disadvantageous that, in order to prevent permeation and leaks, the seal of the fuel pump requires considerable complexity, in particular at the leadthroughs.

### SUMMARY OF THE INVENTION

One aspect of the invention is a pump, in which leaks and permeation are prevented or at least considerably minimized with low complexity.

According to one aspect the connector lines are routed via the inlet side of the pump to the electric motor.

The contact of the electric motor of the fuel pump according to one aspect of the invention can be a leadthrough of the connector lines or a plug connection on the inlet side of the pump.

By the contact being relocated to the suction side of the pump, the differential pressure between the external pressure and the pump internal pressure, which acts on the contact, is reduced, since the contact is not arranged on the outlet side, where the operating pressure, which is generated by the pump, prevails. On account of the lower differential pressure, the complexity of the seal in the region of the contact decreases with a constantly satisfactory or improved sealing action, as a result of which the pump can be manufactured less expensively. As a result of the improved sealing action, it is possible to lower the emissions values of a fuel pump of this type. Secondly, the improved sealing action permits the fuel pump to be operated at a higher operating pressure.

The relocation of the connector lines in the pump requires very little complexity if the connector lines are arranged on the housing inner wall. By way of said refinement, relocation of the connector lines through the electric motor and the pumping stage is avoided.

In one embodiment, reliable routing of the connector lines within the housing is achieved by the housing of the pumping stage having a groove on its circumference, and that the connector lines are arranged in the groove. In the simplest case, the groove is oriented axially.

It is possible in the same way to provide routing of this type in the stator of the electric motor. This is then associated, in particular, with low complexity if routing of this type is arranged, for example, in the return element which belongs to the electric motor. It is also conceivable, however, to utilize gaps or recesses already present for the arrangement of the connector lines.

In one embodiment, the connector lines are routed through the pump housing of the pumping stage. To this end, the pump housing is provided with a bore. The bore can additionally be configured such that it is configured at the same time for receiving the seal to seal the interior of the pump with respect to the surroundings.

A smaller diameter of the pump housing and therefore of the pumping stage is achieved by the fact that, instead of a bore, there is a groove on the circumference of the pump housing of the pumping stage, in which groove the connector lines are arranged. The groove is also advantageously oriented axially.

According to one aspect of the invention the bore can be configured for receiving a plug. As a result, the connector lines can be routed from outside as far as the pump and can be contacted via a plug-in connection with the connector lines that run in the interior of the pump. The split embodiment of the connector lines has the advantage that the electric motor can already be contacted in advance during the assembly of the pump, whereas the contact with the energy supply is performed at a later time, for example when the pump is mounted in a container.

The connector lines to be relocated in the pump can be shortened by the electric motor being arranged between the inlet and the pumping stage according to one advantageous refinement. The refinement permits simplified mounting and less expensive manufacture. In addition, the refinement permits the use of a connector piece known per se as an inlet-side termination of the pump, in order thus to make the contact, but also the connection to the forward feed line, possible.

### BRIEF DESCRIPTION OF THE DRAWINGS

The invention will be explained in greater detail using a plurality of exemplary embodiments. In the drawing:

FIG. 1 is a pump according to an aspect of the invention; and

FIGS. 2 and 3 are further aspects of the pump according to FIG. 1.

### DETAILED DESCRIPTION OF THE PRESENTLY PREFERRED EMBODIMENTS

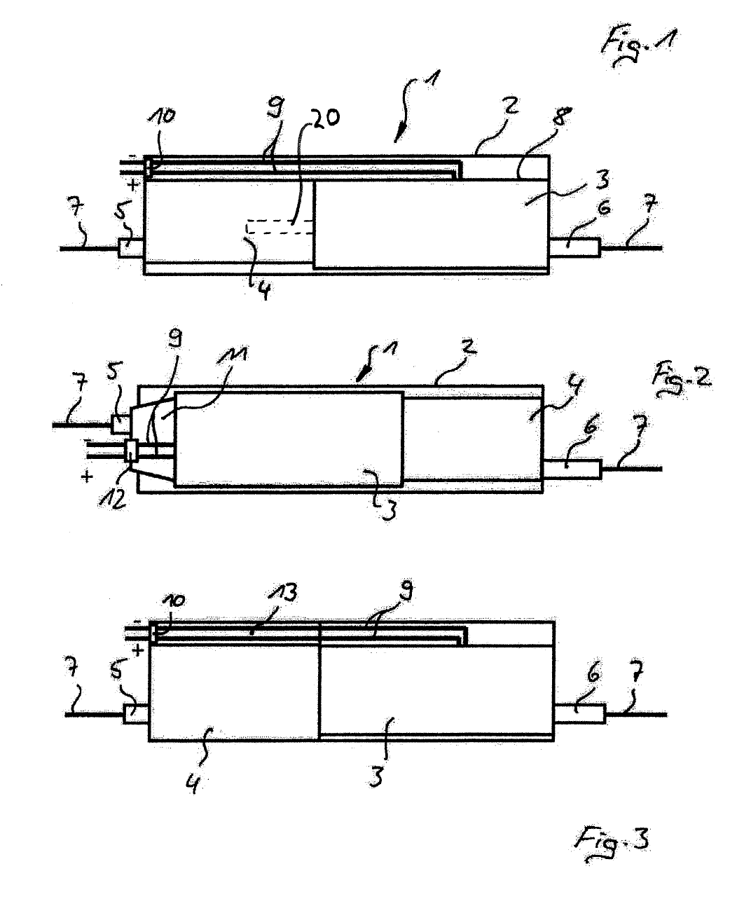

FIG. 1 shows a fuel pump 1 for delivering fuel from a fuel container to the internal combustion engine of a motor vehicle, the fuel pump 1 being arranged outside the fuel container. The fuel pump 1 consists of a housing 2, in which an electric motor 3 and at least one pumping stage 4, which can be driven by a shaft 20 of the electric motor 3 are arranged. An inlet 5 and an outlet 6 are arranged on opposite sides of the fuel pump 1. The inlet 5 is connected via a forward feed line 7 to the fuel container (not shown), with the result that the pumping stage 4 can draw in fuel via said forward feed line 7. From the pumping stage 4, the fuel is subsequently delivered by the electric motor 3 to the outlet 6 and from there via the forward feed line 7 to the internal combustion engine (likewise not shown). The housing 8 of the electric motor 3 is connected in a sealed manner to the pump outlet of the pumping stage 4 and the outlet 6, with the result that fuel delivered from the pumping stage 4 passes directly via the electric motor 3 to the outlet 6. The connector lines 9 for contacting the electric motor 3 are routed laterally out of the housing 8 and to the inlet side of the fuel pump 1. The connector lines 9 are routed out of the fuel pump 1 via a seal 10. The seal 10 is of relatively simple configuration, since a considerably lower pressure prevails in the region of the fuel pump 1, in which the connector lines 9 run, than the delivery pressure which prevails at the outlet 6.

FIG. 2 shows a fuel pump 1 having an inlet 5 and an outlet 6. In contrast to FIG. 1, the electric motor 3 is arranged on the inlet side and the pumping stage 4 is arranged on the outlet side of the fuel pump 1. A connector piece 11 which is known from conventional fuel pumps forms the inlet-side termination of the fuel pump 1, the outlet of which connector piece 11 serves as an inlet 5 in this embodiment. The geometry of the cable leadthrough in the form of a plug 12 is likewise used, with the difference that the seal in the plug 12 for routing through the connector lines 9 is of considerably simpler configuration, since a considerably lower pressure prevails in said region of the fuel pump 1 than the delivery pressure generated by the pumping stage 4. This is achieved by way of the direct and sealed connection of the outlet of the pumping stage 4 to the outlet 6.

The fuel pump 1 in FIG. 3 corresponds substantially to the construction according to FIG. 1. On its circumference, the housing of the pumping stage 4 has an axially running groove 13, in which the connector lines 9 are arranged.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-5. (canceled)

6. A pump comprising:
a housing;
an electric motor arranged in the housing;
at least one pumping stage configured to be driven by a shaft of the electric motor arranged in the housing;
an inlet arranged on a first side of the housing;
an outlet arranged on a second side of the housing that is opposite the first side of the housing; and
connector lines configured to contact the electric motor,
wherein the connector lines are routed via the first side of the pump to the electric motor.

7. The pump as claimed in claim 6, wherein the connector lines are arranged on an inner wall of the housing.

8. The pump as claimed in claim 7, wherein the at least one pumping stage has a housing having a groove on its circumference, the connector lines are arranged in the groove.

9. The pump as claimed in claim 6, wherein the at least one pumping stage has a pump housing and the connector lines are routed through the pump housing.

10. The pump as claimed in claim 6, wherein the electric motor is arranged between the inlet and the at least one pumping stage.
